(19) United States
(12) Patent Application Publication
(10) Pub. No.: US 2018/0038544 A1
(43) Pub. Date: Feb. 8, 2018

(54) ROTATION STABILIZATION DEVICE

(71) Applicant: Jens C. PETERS, Techelsberg/Woerthersee (AT)

(72) Inventor: Jens C. PETERS, Techelsberg/Woerthersee (AT)

(21) Appl. No.: 15/552,414

(22) PCT Filed: Feb. 4, 2016
(86) PCT No.: PCT/AT2016/000008

§ 371 Date: Aug. 21, 2017

(30) Foreign Application Priority Data
Feb. 23, 2015 (AT) A 97/2015

(51) Int. Cl. F16M 11/18; F16M 13/00; F16M 11/10; F16F 15/139; F16M 11/06

(52) U.S. Cl. CPC F16M 11/18; F16F 15/1397; F16M 11/06; F16M 11/10; F16M 13/00; H04N 5/23203

(57) ABSTRACT

A rotation stabilization device has an optical device, in particular a camera, and a position regulation apparatus for the optical device. The optical device is, in a support frame, pivotable about at least one axis of rotation which runs through the center of gravity of the optical device. For stabilization of the optical device, there are situated, on the at least one axis of rotation and between an electric motor and the optical device, a torque converter which stabilizes the optical device in, or moves the optical device into, a desired angular position without abrupt motion.

The invention relates to a rotation stabilization device with an optical apparatus, in particular a camera, and a position adjustment apparatus for the optical apparatus with a support frame, with at least one axis of rotation, which runs through the center of gravity of the optical apparatus, with at least one rotating body, whereby the optical apparatus can be swiveled via at least one rotating body, with at least one electric motor, which drives a rotating body, with a device for determination of spatial orientation of the optical apparatus, in particular a gyroscope, and with a control electronic unit that controls the electric motor.

The invention further relates to a method for operating such a rotation stabilization device.

In broadcasts of sports events, documentaries, concerts, etc., remote-controlled cameras are being used more and more frequently in driven mounts that are fastened to camera cranes, ropes, helicopters, or multicopters. In this case, a camera is located in a frame-like mount.

The camera is swiveled by means of an electric motor along an axis and stabilized. It is common to all known forms of mounts that the cameras that are used (including lenses) are fastened in such a way that the swivel axis and the tilt axis (optionally the roll axes) of the cameras run through the center of gravity thereof. This ensures that no torque forces act on the camera. In the case of deliberate rotation, only the moment of inertia of the camera and its holding device thus needs to be overcome. It is disadvantageous, however, that in the case of a greatly zoomed-in image cutaway of the camera, even the smallest perturbation variables on the holding device can result in an unstable image.

It is known, moreover, that the optical apparatus or the holding device is stabilized and kept constant via a control electronic unit using a position sensor (electric spinner=gyroscope) and a servomotor. The downside to such a purely mechanical coupling of the servomotor to the apparatus that is to be stabilized is evident because of very irregular plots in the case of sequences of movement or in the case of angular stabilization. Especially in the case of compensating movements (caused by perturbation variables) for angular stabilization, only very small movement changes of the camera are necessary. At the beginning and end of each compensating movement, however, volatile behavior can be noted in the motion of the servomotors.

These volatile responses of the adjustment system to perturbation variables result from mechanical friction and mechanical tolerance in the components that are used. Since static friction is greater than sliding friction, volatile behavior can occur during transition from the static friction zone to the sliding friction zone or back again during the transition.

In addition, in many adjustment applications, a servomotor with fitted-on gears is used. Many economical gear manufacturing designs have, however, a so-called gear backlash, which turns out to be an insurmountable problem for a continuous adjustment. Each adjustment movement in the opposite direction to the last movement must overcome this gear backlash and therefore acts too late or too vigorously on the control deviation.

The object of the invention is to provide a stabilization apparatus for the camera, which eliminates mechanical effects of the above-described type on the control behavior.

This object is achieved according to the invention with an apparatus that has the features of Claim 1.

In addition, this object is achieved according to the invention with a method that has the features of Claim 14.

Preferred and advantageous embodiments of the invention are subjects of the subclaims.

According to the invention, it is provided that between the electric motor and the optical device, a torque converter is arranged on the rotating body that is driven by the electric motor and that the position of the optical device is adjusted by a torque converter that is arranged between the electric motor and the optical device on the rotating body that is driven by the electric motor. It is thus achieved that any adjustment response to the perturbation variables takes place without impact or jump. Compensating movements resulting therefrom on the optical apparatus are extremely precise and are subject only to uniform accelerations or delays with smooth transitions. The optical apparatus can therefore be stabilized and kept constant in a specific angular position, whereby the perturbation variables are compensated for.

Within the scope of the invention, optical device is preferably defined as a device for taking and/or reproducing images, in particular a camera.

In a preferred embodiment of the invention, it is provided that a torque converter is a rotary vibration absorber, in particular a hydrodynamic torque converter. The latter can consist of a drum-like, closed housing, which is filled with a highly viscous oil. A sealed drive shaft that is driven on one end of an electric motor runs into the center of the drum. On the other end of the drive shaft, an impeller is located in the drum. This impeller can rotate freely in the drum housing that is filled with oil, and when it is driven outside via the drive shaft, an attempt is made, due to the high viscosity of the oil, to rotate the drum-shaped housing in the same direction as well.

In another embodiment of the invention, another rotating body, in particular a shaft, is arranged on the torque converter on a side of the torque converter that does not point toward the electric motor, in particular on the side opposite to the electric motor. The torque, which is transferred to the drum in the interior of the impeller via the oil, is derived from this rotating body. The torque, with which the drum is entrained, is in a wide range based on the speed of the impeller.

Within the scope of the invention, it can be provided that the additional rotating body, arranged on the torque converter, is a connecting piece between the torque converter and the optical device, in particular that the additional rotating body that is arranged on the torque converter is connected to the optical device or to a holding device of the optical device. Via the torque that is transferred from the drum housing to the rotating body, the holding device is rotated or swiveled around the axis of rotation of the rotating body.

In another advantageous embodiment of the invention, it is provided that the additional rotating body that is arranged on the torque converter and optionally the rotating body that is driven by the electric motor are arranged on the axis of rotation. Because of this arrangement of components, any possible play is prevented from developing by using components transferring additional force.

Another embodiment provides that the support frame has a recess, in particular a hole, and that the additional rotating body, arranged on the torque converter, is guided through a recess of the support frame. It is to be ensured by this embodiment that the axis of rotation preferably runs through the center of gravity of the apparatus, or as close as possible thereto.

Preferably, it is provided that the optical device can be swiveled via the additional rotating body that is arranged on the torque converter. The optical device can thus be swiveled and oriented 360° on the axis of rotation.

An especially preferred embodiment of the invention provides that in each case, a torque converter is provided on two opposite sides of the optical device. The mechanical arrangement of the two units that consist of, in each case, a motor and a torque converter makes it possible that either both motors can rotate in the same rotational direction or, in each case, one can rotate in the direction that is opposite to the other. Since both units acting on an axis are clamped against one another by the mirror-inverted rotation, the torque converter simultaneously also acts as a vibration absorber. The unit can thus also be referred to as a motor/rotary vibration absorber unit.

Within the scope of the invention, it is provided that a device for determination of spatial orientation of the optical device is arranged on the optical device or on a holding device of the optical device, and that an adjustment device adjusts or controls the electric motor via the device for determination of spatial orientation of the optical device. The positional determination of spatial orientation is preferably made by means of a gyroscope. Since the optical device is to be moved or swiveled, position coordinates of the optical device are instrumental.

In the case of another embodiment of the invention, the electric motor has a holding device, whereby the holding device of the electric motor, and optionally the control electronic unit, is connected to the support frame. In order to keep the electric motor static in its position, the latter is arranged on the support frame. The control electronic unit is also located on a support frame in order to avoid having to move unnecessary mass when the optical device is swiveled.

Within the scope of the invention, it can be provided that an axis of rotation runs essentially horizontally in the state of use of the rotation stabilization device. In addition, it can be provided that another axis of rotation is oriented essentially vertically in the state of use of the rotation stabilization device. In addition, it is preferred when the axis of rotation or the axes of rotation runs or run through the center of gravity of the rotation stabilization device. It is especially preferred when the center of gravity of the optical apparatus is identical to the center of gravity of the rotation stabilization device. Because of the axes of rotation that run through the overall center of gravity, normal to one another, which are provided in a preferred embodiment, only the moments of inertia created by the motor/rotary vibration absorber units during a rotation have to be overcome. In this preferred embodiment, very few to no products of inertia occur.

In an especially preferred embodiment of the method according to the invention, it is provided that the position of the optical device is adjusted in such a way that the plot of the torque transferred by the torque converter in a control range is essentially linear to its speed and that the rotation stabilization device is moved in a linear rotary manner in this control range. Uniform movements of the optical device arise because of the linearity between speed and torque of the torque converter. The linear plot of the so-called driving torque of the torque converter is a given, however, only up to a structurally-typical limit speed. In this adjustment system, non-linear regions are avoided, however. The operation is always carried out below the above-mentioned limit speed, where the relationship between speed and driving torque is linear to a large extent. As a special advantage, no volatile sequences of movements occur, as happens, for example, in the case of sequences of movements with servomotors.

Another embodiment of the invention consists in that the position of the optical device is adjusted by two torque converters that are arranged on opposite sides of the optical device, from which in each case another rotating body extends on the axis of rotation. To adjust the optical device, it is provided that the two torque converters are driven in the mirror-inverted direction or in the same direction and/or that the two torque converters are driven at the same speed or at different speeds. The torque converters are especially preferably located on the same axis of rotation. Because of this arrangement and adjustment of the torque converter, a stabilization of the axis or the optical device is achieved. The axis being stabilized or remaining in a desired position can occur when the two rotate on an axis relative to the arranged motor/rotary vibration absorber with the same rough torque but mirror-inverted.

Within the scope of the invention, it can be provided that the rotation around the axes of rotation in the case of mirror-inverted rotational movement of the torque converters comes to a standstill when the torques of the torque converter are of equal value or the sum of the mirror-inverted torques is zero. In addition, it can be provided that the rotation around the axes of rotation in the case of mirror-inverted rotational movement of the torque converter is carried out only when the sum of the torques is not equal to zero, whereby the sum of the torques can have a positive or negative value. In order to deflect the rotary shaft, the speed of the electric motors must be adjusted in such a way that a differential torque is produced from the mirror-inverted rotating torque converters. A rotational movement is produced in the direction in which the torque is greater. The speed of the rotation in this case depends on the magnitude of the torque differential. Stabilization is reached again only when the mirror-inverted torques are again equal in value or the differential of the torques is again zero.

A preferred embodiment provides that the transfer of torque from the electric motor to the torque converter is done in the region of sliding friction, whereby in particular the changes in the torques transferred from the torque converter to the optical device run in a linear manner in the region of sliding friction. In the case of a stationary rotary shaft, the impellers rotate in the drum of the torque converter in opposite directions with a differential torque of zero. These impellers are thus located in the region of sliding friction. In the case of very minor changes in the differential torques, the drive shaft is thus moved with a linear rotation (no occurrence of a jump) of the torque converter. In addition, the axis of motion in the spun state is by the mirror-inverted rotational movement [sic]. In the case of a possible use of a gear for force transfer, gear backlash is thus also eliminated. In the case of major deviations, both motors operate together (direction of rotation in an opposite direction), and the torques of the torque converter are added and are correspondingly large.

The advantages of a unit that consists of an electric motor and a torque converter in comparison to a conventional axis stabilization with a servomotor are:
In the case of a differential torque equal to zero from mirror-inverted rotating torque converters, no static friction and no possible gear backlash exist.
The torque plot can be adapted in an infinitely variable manner from zero to a maximum in a flat adjustment line.
When compensating for a major deviation from the threshold value, one of the two motor/vibration absorber axes must reverse the direction of rotation. The transition from static friction to sliding friction as well as the overcoming of the gear backlash that occurs in this case are lessened by the first strand that is already running in the correct direction of rotation. The associated non-linearity in the torque plot therefore turns out to be minor.

Additional features and advantages of the invention are given in the description below of a preferred embodiment of the invention with reference to the attached drawings.

Here:

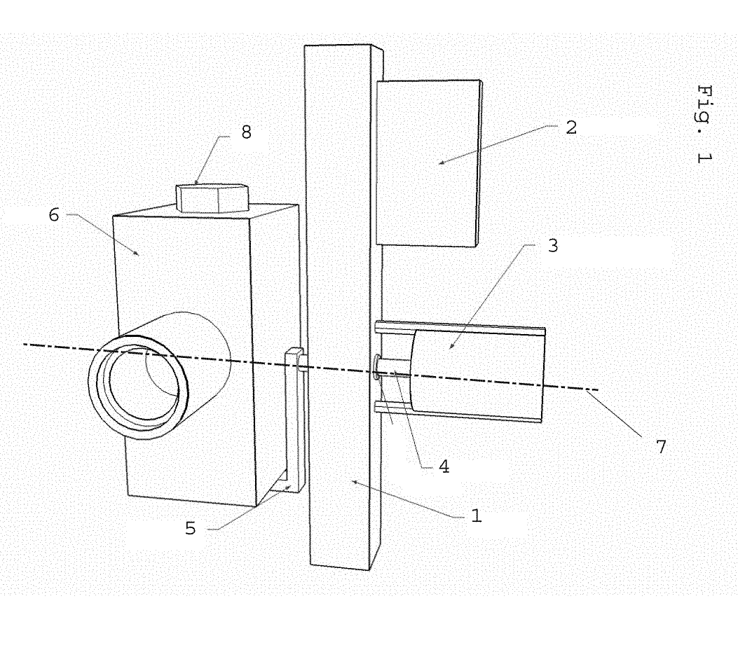

FIG. 1 shows a diagrammatic design of a known camera stabilization,

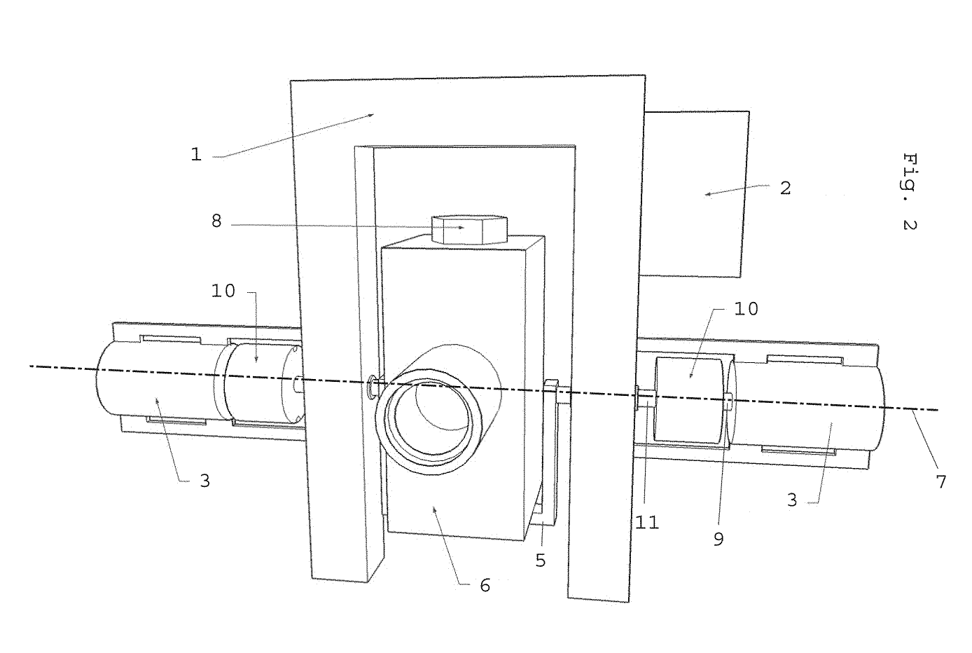

FIG. 2 shows a diagrammatic depiction of an embodiment of an apparatus according to the invention,

FIG. 3 shows an image of a torque plot based on the speed of a torque converter, and

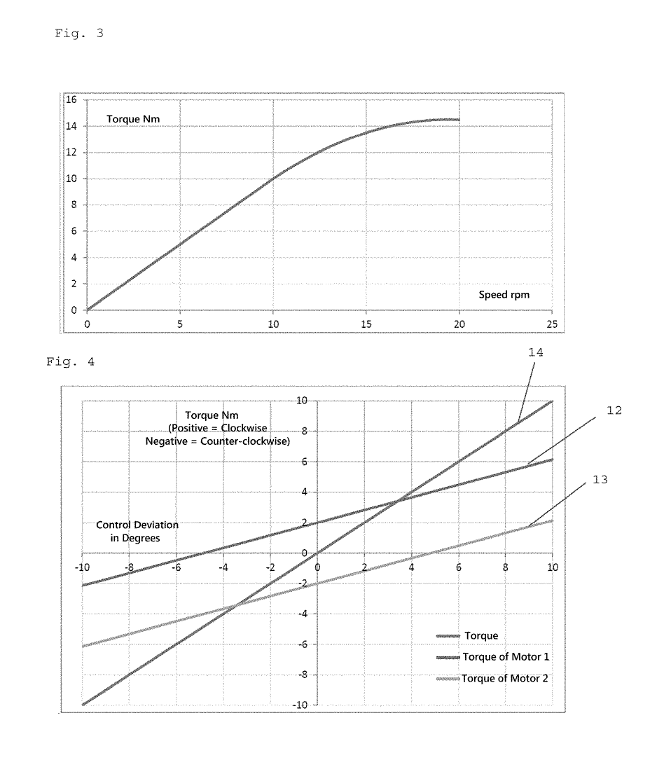

FIG. 4 shows an image of a torque plot based on the control deviation.

In FIG. 1, the diagrammatic design of a known camera stabilization is depicted. A control electronic unit 2 and an electric motor 3 are arranged on a support frame 1. Via a rotating body 4, which runs through the support frame 1, the torque of the electric motor 3 is transferred to a holding device 5. An optical device 6, which can be swiveled around a horizontal axis of rotation 7, is arranged on the holding device 5. In FIG. 1, the optical device 6 is a camera. The axis of the rotating body 4 runs with the axis of rotation 7 through the center of gravity of the optical device 6. Thus, only the moments of inertia of the elements to be rotated have to be overcome. In order to adjust the electric motor 3 via the control electronic unit 2, a gyroscope 8 is provided to determine the position of the optical device 6.

In FIG. 2, an embodiment of an apparatus according to the invention is diagrammatically depicted, which in principle is constructed similarly to the apparatus described in FIG. 1. In contrast to the apparatus that is shown in FIG. 1, the apparatus that is shown according to the invention in each case has an electric motor 3 on both sides of the support frame 1, which motor in each case drives a rotating body 9. Between the electric motors 3 and the optical device 6, in each case a torque converter 10 is arranged on the rotating body 9 that is driven by the electric motor 3. Starting from the torque converters 10, in each case another rotating body 11 is arranged in the direction toward the optical device 6, which runs through a recess in the support frame 1 and is connected to the holding device 5, by which the optical device 6 can be swiveled around the axis of rotation 7.

For the sake of a better overview, an apparatus that can swivel only around a horizontal axis of rotation 7 is depicted. In other embodiments, the device can also be swiveled via additional axes of rotation, for example via a vertical axis of rotation or via another horizontal axis of rotation, which runs in particular perpendicular to the axis of rotation 7. The axis of rotation 7 runs through the center of gravity of the rotation stabilization device and is identical to the axes of the rotating body 9, 11.

In FIG. 3, the course of the torque of a torque converter 10 based on the speed is depicted. In this case, it can be seen that in a large region, torque runs linearly with respect to speed. Only in the last third does the torque asymptotically approach a constant maximum value. This maximum value varies in a structurally-typical manner. To adjust or stabilize the position of the optical device 6, adjustment between speed and torque is preferably done only in the region of linear dependency.

In FIG. 4, a linear torque plot based on control deviation is depicted in degrees [°]. The mechanical arrangement of the two units that consist of electric motor 3 and torque converter 10 makes it possible that either both electric motors 3 can rotate in the same direction of rotation or in each case one can rotate in the opposite direction to the other, and this for each electric motor 3 with in each case different speeds. The diagram illustrates at what torque (=based on the speed) the units that consist of electric motor 3 and torque converter 10 are to react in the case of positive or negative control deviations. The slopes of the two motor/rotary vibration absorber lines 12, 13 as well as the line 14 with the total torque are added to the diagram and depict only one example of a control adjustment. It is essential that the two torques always have an amount that is of the same value but act in opposite directions in the case of a zero control deviation, i.e., the two torques cancel each other out at this point.

The special feature in the use of a combination that consists of electric motor 3 and torque converter 10 lies in the possibility of operating the electric motors 3 even when the outlet of the corresponding torque converter 10 is blocked. This blocking is achieved in such a way that the second combination that consists of electric motor 3 and torque converter 10 works at the speed that is the same but acts in the direction that is opposite to that of the first combination.

In the case of minor control deviation values (in the diagram, between 0° to +5° or 0° to −5°), the directions of rotation of the two units, consisting of electric motor 3 and torque converter 10, are opposite, and thus only differential torque acts on the rotating body 11. In the case of major deviations, the electric motors 3 operate with one another (direction of rotation in the same direction), and the torques of the torque converter 10 are added and are therefore corresponding large.

This also means, however, that at the zero point (i.e., no control deviation is present=holding device 5 is correct), the two servomotors 3 additionally rotate in opposite directions at the same (lower) speed. The differential torque is zero and therefore the rotating body 11 or the optical device 6 is stationary with motors running. The rotating body 11 including the two units are clamped to one another; gear backlash is thus eliminated. Static friction is overcome just by the continuous rotation of the impellers in the interior of the torque converter 10, and the state of sliding friction prevails. Therefore, in the case where a deviation is compensated for again, there is no longer any static friction or gear backlash to overcome.

1. Rotation stabilization device with an optical device (6), in particular a camera, and a position adjustment apparatus for the optical device (6) with a support frame (1), with at least one axis of rotation (7), which runs through the center of gravity of the optical device (6), with at least one rotating body (9, 11), whereby the optical device (6) can be swiveled via at least one rotating body (11), with at least one electric motor (3), which drives a rotating body (9), in particular a shaft, with a device for determination of spatial orientation of the optical device (6), in particular a gyroscope (8), and with a control electronic unit (2) that controls the electric motor (3), wherein between the electric motor (3) and the optical device (6), a torque converter (10) is arranged on the rotating body (9) that is driven by the electric motor (3).

2. Rotation stabilization device according to claim 1, wherein the torque converter (10) is a rotary vibration absorber, in particular a hydrodynamic torque converter.

3. Rotation stabilization device according to claim 1, wherein another rotating body (11), in particular a shaft, is arranged on the torque converter (10) on a side of the torque converter (10) that does not point toward the electric motor (3), in particular on the side opposite to the electric motor (3).

4. Rotation stabilization device according to claim 1, wherein the additional rotating body (11), arranged on the torque converter (10), is a connecting piece between the torque converter (10) and the optical device (6), in particular that the additional rotating body (11) that is arranged on the torque converter (10) is connected to the optical device (6) or to a holding device (5) of the optical device (6).

5. Rotation stabilization device according to claim 1, wherein the additional rotating body (11) that is arranged on the torque converter (10) and optionally the rotating body (9) that is driven by the electric motor (3) are arranged on the axis of rotation (7).

6. Rotation stabilization device according to claim 1, wherein the support frame (1) has a recess, in particular a hole, and wherein the additional rotating body (11) that is arranged on the torque converter (10) is guided through the recess.

7. Rotation stabilization device according to claim 1, wherein the optical device (6) can be swiveled via the additional rotating body (11) that is arranged on the torque converter (10).

8. Rotation stabilization device according to claim 1, wherein in each case, a torque converter (10) is provided on two opposite sides of the optical device (6).

9. Rotation stabilization device according to claim 1, wherein the device for determination of spatial orientation of the optical device (6) is arranged on the optical device (6) or on a holding device (5) of the optical device (6) and wherein the control unit (2) adjusts or controls the electric motor (3) via the device for determination of spatial orientation of the optical device (6).

10. Rotation stabilization device according to claim 1, wherein the electric motor (3) has a holding device and wherein the holding device of the electric motor (3), and optionally the control electronic unit (2), is connected to the support frame (1).

11. Rotation stabilization device according to claim 1, wherein an axis of rotation (7) runs essentially horizontally in the state of use of the rotation stabilization device and/or wherein an axis of rotation is oriented essentially vertically in the state of use of the rotation stabilization device.

12. Rotation stabilization device according to claim 1, wherein the axis of rotation (7) or the axes of rotation runs or run through the center of gravity of the rotation stabilization device.

13. Rotation stabilization device according to claim 1, wherein the center of gravity of the optical device (6) is equal to the center of gravity of the rotation stabilization device.

14. Method for operating a rotation stabilization device with an optical apparatus (6), in particular a camera, and a position adjustment apparatus for the optical apparatus (6) with a support frame (1), with at least one axis of rotation (7), which runs through the center of gravity of the optical device (6), with at least one rotating body (9, 11), whereby the optical device (6) can be swiveled via at least one rotating body (11), with at least one electric motor (3), which drives a rotating body (9), in particular a shaft, with a device for determination of spatial orientation of the optical device (6), in particular a gyroscope (8), and with a control electronic unit (2), which controls the electric motor (3), wherein the position of the optical device (6) is adjusted by a torque converter (10) that is arranged between the electric motor (3) and the optical device (6) on the rotating body (9) that is driven by the electric motor (3).

15. Method according to claim 14, wherein the position of the optical device (6) is adjusted in such a way that the plot of the torque transferred by the torque converter (10) in a control range is essentially linear to its speed and in that the rotation stabilization device is moved in a linear rotary manner in this control range.

16. Method according to claim 14 or wherein the position of the optical device (6) is adjusted by two torque converters (10) that are arranged on opposite sides of the optical device (6), from which in each case an additional rotating body (11) extends on the axis of rotation (7).

17. Method according to claim 16, wherein the two torque converters (10) are driven in the mirror-inverted direction or in the same direction and/or at the same speed or at different speeds.

18. Method according to claim 16, wherein the rotation around the axis of rotation (7) in the case of mirror-inverted rotational movement of the torque converter (10) comes to a standstill when the torques of the torque converter (10) are of equal value or the sum of the mirror-inverted torques is zero.

19. Method according to claim 17, wherein the rotation around the axis of rotation (7) in the case of mirror-inverted rotational movement of the torque converter (10) is carried out when the sum of the torques is not equal to zero.

20. Method according to claim 17, wherein the transfer of torque from the electric motor (3) to the torque converter (10) is done in the region of sliding friction, in particular wherein the changes in the torques transferred from the torque converter (10) to the optical device (6) run in a linear manner in the region of sliding friction.
